(19) United States
(12) Patent Application Publication
(10) Pub. No.: US 2006/0199586 A1
(43) Pub. Date: Sep. 7, 2006

(54) Apparatus and method for providing call service in wireless local area network (LAN) system

(76) Inventor: Joo-Yeol Yoon, Gunpo-si (KR)

Correspondence Address: Robert E. Bushnell, Suite 300, 1522 K Street, N.W., Washington, DC, 20005, US

(21) Appl. No.: 11/352,349

(22) Filed: Feb. 13, 2006

(30) Foreign Application Priority Data
Mar. 7, 2005 (KR) 2005-18869

(51) Int. Cl. H04Q 7/20

(52) U.S. Cl. 455/437; 455/509; 455/450

(57) ABSTRACT

In a method and apparatus for providing call service in a wireless local area network system, when the number of calls that can be established via an AP has reached a maximum value in the wireless local area network system, communication state information for a plurality of APs is managed and automatic roaming to a neighboring AP to establish a call is performed upon receipt of a call request. Also, when a wireless terminal having an established call is required to hand-over to a neighboring AP, call termination and quality deterioration are prevented by not performing hand-over when the neighboring AP is in a busy state.

### CLAIM OF PRIORITY

This application makes reference to, incorporates the same herein, and claims all benefits accruing under 35 U.S.C. §119 from an application for APPARATUS AND METHOD FOR PROVIDING CALL SERVICE IN WIRELESS LOCAL AREA NETWORK (LAN) SYSTEM, earlier filed in the Korean Intellectual Property Office on Mar. 7, 2005 and there duly allocated Serial No. 2005-18869.

### BACKGROUND OF THE INVENTION

1. Technical Field

The present invention relates to a method and apparatus for providing call service in a wireless local area network system and, more particularly, to a method and apparatus for providing call service in a wireless local area network system, the method and apparatus being capable of managing communication state information depending on traffic capacity of an access point, allowing a call to be established via an access point in an idle state, and allowing a wireless terminal to connect to a neighboring idle access point within a shortest time period upon hand-over.

2. Related Art

Wireless local area networks (WLANs) include everything from a hub to terminals built using wireless frequencies or light, rather than cables, in an indoor or outdoor environment within a limited space such as a building, an office, a home and the like.

WLAN is a local area wireless communication technique that uses a wireless access protocol, such as IEEE 802.11, in a 2.4/5 GHz unlicensed frequency band. WLAN has been developed as a substitute for cable LAN, and is mainly used to build small-scale wireless network environments within companies.

However, recent WLAN techniques have shifted from a wired LAN technique to a public network technique that provides broadband wireless Internet access service to subscribers.

WLAN is composed of collections of stations called basic service sets (BSSs). BSSs may be basically classified into independent BSSs and infrastructure BSSs.

A station is an entity, such as a network interface card (NIC) mounted on a personal computer (PC) or a notebook computer, and a wireless terminal, that gains access using a wireless medium.

In the independent BSS, communication between stations is performed within a limited range of distance without using an access point (AP). That is, terminals communicate by building an ad-hoc network without connecting to a wired network such as a LAN.

In the infrastructure BSS, each BSS includes one access point connected to a wired network. The AP registers and authenticates terminals within the BSS, and performs roaming and moving processes on stations. The AP also has additional functions, such as firewall, NATs, DHCP server/client, VPN, and the like.

In the BSS mode, an AP acts as an access point for a wired communication network. A typical premises environment includes one AP for several terminals. The 802.11 standard supports Intra-BSS mobility, and accordingly, a wireless terminal is able to receive the same service everywhere so long as it is located within range of the AP.

Several BSSs may be interconnected via a backbone network to cover an extended area. Such a backbone network of BSSs is called a distributed system (DS).

The respective BSSs are distinguished by a 48-bit BSS identifier (ID), which is similar to a MAC address for an 802.3 LAN. It is possible to provide WLAN service within a wide area by building a distributed system in places such as a campus or a conference center.

When a wireless terminal roams from one BSS to another BSS in a wireless local area network, the DS enables users to freely roam and to receive packets at a new position. The DS may be configured as any type of network, but is generally an 802.3 LAN. A structure in which at least two BSSs are connected to a DS to build one subnetwork is called an extended service set (ESS).

ESSs are distinguished by an ESS ID. Wireless terminals always belong to a specific BSS and ESS. When a wireless terminal moves from one BSS to another BSS, both belonging to the same ESS, packets should be properly routed to the moving terminal.

A routing AP has the function of routing packets to another terminal in a BSS, or to another BSS in the same ESS.

The wireless terminal may be a notebook computer, a smart card, a VoIP phone, etc. which is capable of WLAN voice/data communication.

As a result, the AP is an entity that connects a wireless medium and a wired medium. That is, the AP acts as a base station for a WLAN device so as to provide a connection to a wired communication network such as a LAN.

When voice communication service is provided in the wireless local area network system, each AP serves a limited number of wireless terminals.

That is, a wireless terminal which uses a wireless local area network system to provide a voice communication service is connected, via an AP, to a server which controls voice communication calls.

There are several standards (e.g., G.279, G.711, and G.723) having different voice information sampling and compressing schemes in a method by which the wireless terminal and the server translate an exchanged IP packet into a stream. Voice communication service is provided by generating streaming data from voice information, or restoring streaming data, according to a standard determined by whether the network is a wired LAN or a wireless LAN.

A wireless terminal uses a type of successive streaming data obtained by IP-packetizing voice data. For smooth communication, proper traffic should be guaranteed. The number of wireless terminals simultaneously serviced by an AP or a call connection server is limited so as to guarantee voice streaming traffic for each wireless terminal.

When the number of wireless terminals serviced by an AP reaches a limit, all communication channels of the AP become busy, i.e., communication is impossible.

A wireless terminal connected to a busy AP is connected to a new AP through a scanning process which searches for a neighboring available AP to which the wireless terminal can roam, an authentication process, an association process for establishing a link by connecting to the new AP, etc.

In this case, the wireless terminal repeatedly performs the scanning process to select an AP having sufficient exchanged signal strength, and then roams to the selected AP.

Accordingly, when links to an AP are already established by the maximum number of wireless terminals that can be serviced through link establishment and there is a call service request from a new wireless terminal, the AP refuses the new service request in order to guarantee traffic for the wireless terminals that are already connected, and to which call service is already being provided. When the AP refuses the service request, the new wireless terminal artfully searches for an AP that can provide call service, and then roams to utilize the call service.

APs are more densely disposed in regions dense with wireless terminals. When a current AP is busy, a wireless terminal in a region where several AP service areas overlap is nevertheless unable to roam to a neighboring AP in a non-busy state when the signal strength of the current AP is sufficient. The wireless terminal is forced to roam to a remote AP instead of the neighboring AP.

A wireless terminal scans for an AP to roam to when a currently connected AP is busy. However, when a signal exchanged with the AP having the currently established link is sufficiently strong, the wireless terminal does not roam to another AP, but maintains the current link with the busy AP. That is, the wireless terminal determines whether to roam based on connection strength. When the strength of the connection with the current busy AP is sufficient, the wireless terminal does not roam to another AP, and consequently a new call cannot be established.

Furthermore, in the case where the wireless terminal has an automatic roaming function, the wireless terminal repeatedly scans for an AP to roam to, thereby increasing roaming time.

### SUMMARY OF THE INVENTION

It is an object of the present invention to provide a method and apparatus for providing call service in a wireless local area network system, wherein a server manages communication state information of respective access points (APs) and allows a wireless terminal to establish a call via an AP in an idle state, thereby minimizing time consumed in roaming.

According to an aspect of the present invention, there is provided a wireless local area network system including a plurality of wireless terminals and at least one access point (AP), the system including: a server for transmitting a communication state response message, including communication state information depending on information about scanned APs, to the wireless terminal upon receipt of a communication state request message, including the information about the APs from the wireless terminal; and at least one wireless terminal for transmitting the communication state request message, including the information about the APs, to the server, and for making a wireless connection to an AP in an idle state according to the communication state information included in the communication state response message.

The wireless terminal generates the communication state request message including address information of at least one scanned AP.

The wireless terminal also transmits the communication state request message to the server prior to transmitting a call service request message to the server in response to a user's request.

When the wireless terminal determines that hand-over to a second neighboring AP is required in a state where a call is established via a first AP, the wireless terminal transmits the communication state request message, including unique information about the respective scanned APs, to the server, and maintains the call established via the first AP when communication state information for the second AP recognized from the received communication state response message indicates a busy state.

The server assigns identification information to the respective APs, and manages at least one of the identification information assigned to the respective APs, address information, information on a number of calls that can be established, information on a number of currently established calls, and communication state information which depends on the information on the number of calls that can be established, and the information on a number of currently established calls.

The server transmits the communication state response message to the wireless terminal, the communication state response message including communication state information which corresponds to information unique to each AP included in the communication state request message received from the wireless terminal.

The communication state request message includes at least one of information unique to each wireless terminal, information on a number of scanned APs, and MAC address information of the APs.

The information unique to each wireless terminal may be any one of MAC address information, identification information assigned by the server, telephone number information, and base service set (BSS) ID information.

The communication state response message may include at least one of information unique to the wireless terminal transmitting the communication state request message, information on a number of the APs, MAC address information for the server, MAC address information for the APs, and communication state information for the APs.

According to another aspect of the present invention, there is provided a server for providing call service in a wireless local area network system including at least one wireless terminal and access points (APs), the server including: an information manager for recognizing communication state information from information on a number of calls established via each AP, and for transmitting a communication state response message to the wireless terminal, the communication state response message including communication state information for APs, in response to a received communication state request message from the wireless terminal; and a call processor for transmitting a call service request message from the wireless terminal to a receiving wireless terminal, and then establishing a call via the AP to which the wireless terminal is connected.

The information manager recognizes information on the number of calls that can be established and information on the number of currently established calls for each AP, and when the numbers are the same, the information manager recognizes the communication state information for the corresponding AP to be busy state information.

According to still another aspect of the present invention, there is provided a wireless terminal for a wireless local area network system including a plurality of access points (APs) and a call service providing server, the terminal including: a message processor for transmitting a communication state request message to the server so as to request communication state information for scanned APs, and for providing the communication state information included in a received communication state response message; and a controller for making a wireless connection to an AP in an idle state according to the communication state information provided by the message processor, and then transmitting a call service request message to the server.

The terminal further includes a roaming processor for processing roaming according to communication state information for a second neighboring AP provided by the message processor when it is determined that hand-over to the second AP is required based on the strength of a signal exchanged with a first AP to which the controller has made a wireless connection.

The roaming processor maintains a call established via the first AP when the communication state information for the second AP is busy state information.

According to yet another aspect of the present invention, there is provided a method for providing call service in a wireless local area network system including at least one wireless terminal, access points (APs), and a call service providing server, the method including the steps of: recognizing, by means of the server, communication state information for APs connected over a network; transmitting, by means of each wireless terminal, a communication state request message to the server so as to request the communication state information on scanned APs; transmitting, by means of the server, a communication state response message, including the communication state information for the APs, to the wireless terminal; making, by means of the wireless terminal, a wireless connection to an AP in an idle state based on the communication state information in the communication state response message, and then transmitting a call service request message to the server; and establishing, by means of the server, a call with the wireless terminal via the AP in the idle state.

The method further includes the steps of: transmitting, by means of the wireless terminal, the service request message to the server; transmitting, by means of the server, a busy message to the wireless terminal when the communication state information of an AP to which the wireless terminal is connected is busy state information; transmitting, by means of the wireless terminal, the communication state request message to the server upon receipt of the busy message; and roaming, by the wireless terminal, to a neighboring AP, and then transmitting the service request message to the server when the communication state information for the neighboring AP included in the received communication state response message is idle state information.

The step of recognizing communication state information for the APs includes the steps of: assigning, by means of the server, identification information to the APs connected over the network and recognizing address information; recognizing information on the number of calls that can be established and information on the number of currently established calls for each AP; storing communication state information depending on the information on the number of calls that can be established and the information on the number of currently established calls, so as to correspond to identification information or address information of the respective APs; and incrementing or decrementing the information on the number of the currently established calls so as to update the communication state information when the call is established or terminated via each AP.

The method further includes the steps of: transmitting, by means of the respective wireless terminal, the communication state request message to the server when it is determined that hand-over to the second AP is required based on the strength of a signal exchanged in a state wherein a call is established via the first AP; and maintaining, by means of the wireless terminal, the call established with the first AP when the communication state information for the second AP included in the communication state response message received from the server indicates a busy state.

According to still yet another aspect of the present invention, there is provided a is method for providing call service in a wireless local area network system including at least one wireless terminal, access points (APs), and a call service providing server, the method including the steps of: recognizing communication state information based on information on the number of calls that can be established and information on the number of currently established calls for each AP; transmitting a communication state response message, including communication state information for the respective APs and information unique to each AP, to a wireless terminal upon receipt of a communication state request message from the wireless terminal; and establishing a call for providing the service in response to a received service request message from the respective wireless terminals.

The information unique to each AP is any one of identification information assigned to the AP by the server, IP address information, and MAC address information.

According to still yet another aspect of the present invention, there is provided a method for providing call service in a wireless terminal for a wireless local area network system including a plurality of access points (APs) and a call service providing server, the method including the steps of: transmitting a communication state request message to the server so as to request communication state information for scanned APs, and then recognizing communication state information for the APs from a received communication state response message; selecting a second AP which is in an idle state and which has excellent signal strength when communication state information of a first AP of the scanned APs having the highest signal strength indicates a busy state; and making a wireless connection to the second AP through an authentication process and an association process so as to transmit a call service request message to the server.

The method further includes the steps of: transmitting the communication state request message to the server when it is determined that hand-over to the second AP is required based on the strength of a signal exchanged while a call is established via the first AP; maintaining the call established with the first AP when the communication state information for the second AP indicates a busy state; and performing hand-over to the second AP through an authentication process and an association process when the communication state information for the second AP indicates an idle state.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a wireless local area network system according to the present invention;

FIG. 2 is a block diagram of the internal structure of a VoIP server according to a preferred embodiment of the present invention;

FIG. 3 is a block diagram of the internal structure of a wireless terminal according to a preferred embodiment of the present invention;

FIG. 4 is a flowchart illustrating establishment of a call in a wireless terminal according to a preferred embodiment of the present invention;

FIG. 5 is a flowchart illustrating a method for providing call service in a wireless local area network system according to a first preferred embodiment of the present invention;

FIG. 6A is a diagram of a message according to a preferred embodiment of the present invention;

FIG. 6B is a diagram of a position confirmation message according to an embodiment of the present invention;

FIG. 6C is a diagram of a communication state request message according to a preferred embodiment of the present invention;

FIG. 6D is a diagram of a communication state response message according to an embodiment of the present invention; and

FIG. 7 is a flowchart illustrating a method for providing call service in a wireless local area network system according to a second preferred embodiment of the present invention.

### DETAILED DESCRIPTION OF THE INVENTION

A method and apparatus for providing call service in a wireless local area network system according to the present invention will now be described more fully with reference to the accompanying drawings.

While a case where a call is established to provide voice communication service in a wireless local area network system will be described below, the present invention also applies to a case where data communication service is provided in a wireless local area network system.

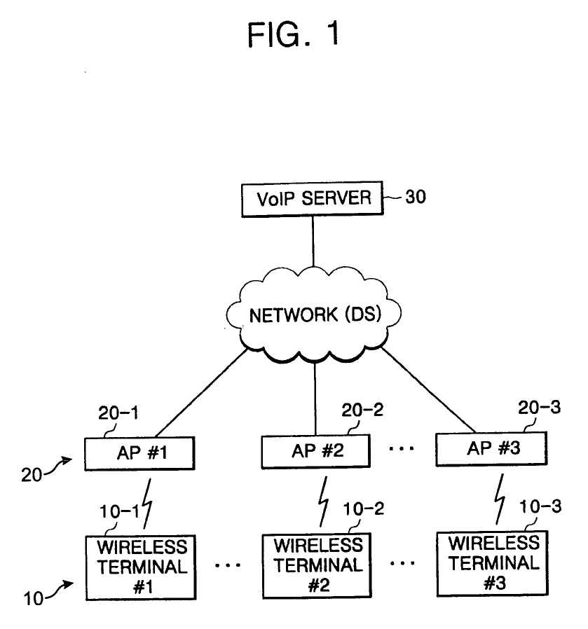

FIG. 1 is a block diagram of a wireless local area network system according to the present invention.

Referring to FIG. 1, the wireless local area network system according to the present invention includes a plurality of wireless terminals 10, a plurality of access points APs 20 connected wirelessly to the plurality of wireless terminals 10, and a VoIP server 30 connected to the respective APs 20 over a network (i.e., a backbone network).

Each of the APs 20 provides an interface such that a wireless terminal 10-1, 10-2 or 10-3 contained in its service area is connected to the VoIP server 30 over the network, and provides routing such that the wireless terminal 10-1, 10-2 or 10-3 and the VoIP server 30 exchange packets.

Each of the APs 20 is positioned in a certain area according to a number of the wireless terminals 10 that may attempt to connect at the same time. In a region where there may be multiple wireless terminals 10 provided with services at a given time, a plurality of neighboring APs 20 are disposed in such a manner that service areas overlap.

Each of the APs 20 can be connected to a wireless terminal 10-1, 10-2 or 10-3 and to the VoIP server 30 through MAC address information. Each of the APs 20 transmits packets and messages wirelessly received from each of the wireless terminals 10 to the VoIP server 30 over a wired communication network, and transmits packets and messages received from the VoIP server 30 to any of the wireless terminals 10 over a wireless communication network. That is, the APs 20 perform switching such that the wireless communication network and the wired communication network are interconnected.

The VoIP server 30 dynamically assigns IP address information to each of the wireless terminals 10 connected to the VoIP server 30 via a respective one of the APs 20, and manages communication state information for the respective APs 20, position information of the respective wireless terminals 10, and the like.

When the VoIP server 30 receives a call request message from one of the wireless terminals 10, the VoIP server 30 establishes a VoIP call between the calling wireless terminal and a receiving wireless terminal.

When the VoIP server 30 also receives a communication state request message from one of the wireless terminals 10, the VoIP server 30 transmits a communication state response message based on communication state information for a respective one of the APs 20 that can be wirelessly connected to the respective one of the wireless terminals 10. That is, the VoIP server 30 manages communication state information depending on the number of calls established via respective ones of the APs 20 connected over the network and, upon receipt of the communication state request message from one of the wireless terminals 10, transmits a communication state response message including communication state information for a respective one of the APs 20 to the relevant one of the wireless terminals 10.

In initial operation, each of the wireless terminals 10 is wirelessly connected to one of the APs 20 through a scanning process that searches for an AP having sufficient signal strength and allowing a wireless connection, an authentication process for making a connection to a scanned one of the APs 20, and an association process for wirelessly establishing a link with a relevant one of the APs 20.

When one of the wireless terminals 10 wirelessly connects to one of the APs 20 having sufficient signal strength and generates a call request message to establish a VoIP call with another wireless terminal in response to a subscriber's selection, it inquires of the VoIP server 30 whether a call can be established via the wirelessly connected AP and establishes a call via a neighboring one of the APs 20 when the call cannot be established via another one of the APs 20.

That is, the wireless terminal 10 transmits the communication state request message to the VoIP server 30 so as to request communication state information for the respective one of the APs 20, and then recognizes the communication state information for the respective one of the APs 20 included in the communication state response message received from the VoIP server 30.

When an AP 20-1, 20-2 or 20-3 to which a wireless terminal 10-1, 10-2 or 10-3 is currently wirelessly connected becomes busy, the wireless terminal 10-1, 10-2 or 10-3 wirelessly connects to a neighboring AP 20-1, 20-2 or 20-3 in an idle state, and then transmits a call request message to the VoIP server 30.

When the VoIP server 30 receives the call request message from the wireless terminal 10-1, 10-2 or 10-3, it establishes a call via the AP 20-1, 20-2 or 20-3 to which the wireless terminal 10-1, 10-2 or 10-3 is wirelessly connected, and then updates communication state information for the AP 20-1, 20-2 or 20-3. That is, the VoIP server 30 increments a set number of calls in the AP 20-1, 20-2 or 20-3.

The VoIP server 30 decrements the set call number in the AP 20-1, 20-2 or 20-3 when the call is terminated.

Further, when the wireless terminal 10-1, 10-2 or 10-3 moves with a call established with an AP 20-1, 20-2 or 20-3 and the strength of the signal exchanged with the AP 20-1, 20-2 or 20-3 becomes insufficient, the wireless terminal 10-1, 10-2 or 10-3 does not perform the scanning process to roam to a neighboring AP 20-1, 20-2 or 20-3, but inquires of the VoIP server 30 about the communication state of a neighboring AP 20-1, 20-2 or 20-3. When the neighboring AP 20-1, 20-2 or 20-3 is not busy, the wireless terminal 10-1, 10-2 or 10-3 does not perform the scanning process but automatically roams to save time.

In other words, when the call is established and the strength of the signal exchanged with the wirelessly connected AP 20-1, 20-2 or 20-3 becomes weak, the wireless terminal 10-1, 10-2 or 10-3 transmits the communication state request message to the VoIP server 30 to inquire about the communication state of the respective scanned APs 20-1, 20-2 or 20-3. The wireless terminal 10-1, 10-2 or 10-3 roams to an AP 20-1, 20-2 or 20-3 in an idle state determined from the communication state information included in the communication state response message received from the VoIP server 30. That is, the wireless terminal 10-1, 10-2 or 10-3 does not scan for an AP 20-1, 20-2 or 20-3 to roam to, but rather selects an AP 20-1, 20-2 or 20-3 to roam to based on the communication state information of the AP 20-1, 20-2 or 20-3 scanned upon making an initial wireless connection, and then roams through the authentication and association processes.

Meanwhile, when the communication state of the neighboring AP 20-1, 20-2 or 20-3 is a busy state indicating that communication is impossible, the wireless terminal 10-1, 10-2 or 10-3 stops hand-over to roam to the AP 20-1, 20-2 or 20-3, thereby preventing call termination or communication quality degradation.

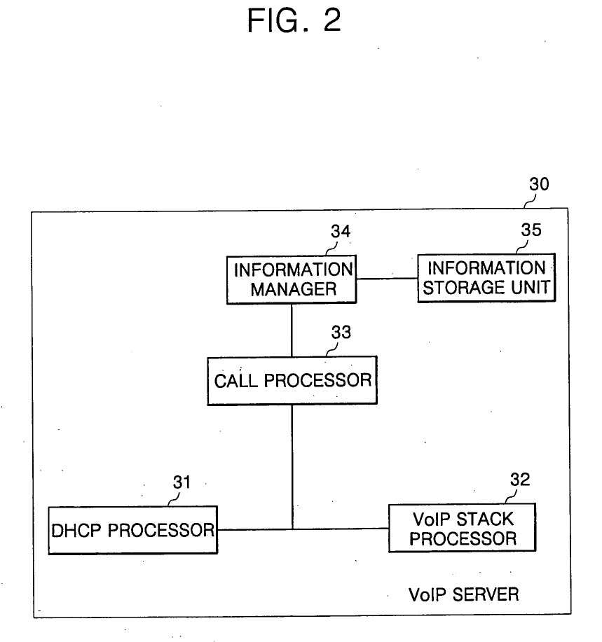

FIG. 2 is a block diagram of the internal structure of a VoIP server according to a preferred embodiment of the present invention.

Referring to FIG. 2, the VoIP server 30 according to the present invention includes a dynamic host configuration protocol (DHCP) processor 31, a VoIP stack processor 32, a call processor 33, an information manager 34, and an information storage unit 35.

The VoIP stack processor 32 provides an interface so that the wireless terminals 10 and the VoIP server 30 are able to exchange VoIP messages or packets via the APs 20. That is, the VoIP stack processor 32 processes the VoIP messages or packets according to VoIP protocol, processes packets or messages generated by the VoIP server 30 according to VoIP protocol, and transmits them to the network.

Session initiation protocol (SIP), media gateway control protocol (MGCP), H.323, and the like are defined in the VoIP. SIP is a simple text-based application layer control protocol, and allows one or more participants to establish/modify/terminate sessions together. Sessions include Internet-based remote conferences, telephone conversations, event notices, instant messaging, and the like.

MGCP is also known as “H.248” or “Megaco”, and is a standard protocol for signal operation and session management required for multimedia conferencing. H.323 is a standard defined by “ITU-T” to transmit multimedia image conference data over a network of a packet exchange system, such as TCP/IP.

The DHCP server 31 dynamically assigns IP address information to each wireless terminal 10-1, 10-2 or 10-3 connected via an AP 20-1, 20-2 or 20-3, so that the wireless terminals 10 connect to the network through IP address information.

The call processor 33 recognizes incoming information from the call request message received from the wireless terminal 10-1, 10-2 or 10-3 and establishes a call between a calling wireless terminal and a receiving wireless terminal transmitting the call request message, or terminates an established call when a call termination message is received from the calling wireless terminal or the receiving wireless terminal. That is, the call processor 33 controls calls of the wireless terminals 10 connected to the network via the APs 20.

The information manager 34 manages position information of each wireless terminal 10-1, 10-2 or 10-3 connected via an AP 20-1, 20-2 or 20-3 and communication state information for each AP 20-1, 20-2 or 20-3.

That is, the information manager 34 assigns identification information to each AP 20-1, 20-2 or 20-3 connected over the network, and then manages traffic of each AP 20-1, 20-2 or 20-3, i.e., communication state information, depending on the number of calls established via each AP 20-1, 20-2 or 20-3.

The information manager 34 also manages unique information about the wireless terminals 10 wirelessly connected to each of the APs 20 (e.g., MAC address information and IP address information), and unique information about the APs 20 to which each of the wireless terminals 10 is connected.

The position information of each wireless terminal 10-1, 10-2 or 10-3 managed by the information manager 34 is information for searching for an AP 20-1, 20-2 or 20-3 with which the VoIP server 30 will establish a call in response to the received call request message.

After the information manager 34 assigns identification information to each AP 20-1, 20-2 or 20-3, it also manages communication state information depending on the number of calls that can be established via each AP 20-1, 20-2 or 20-3 and the number of calls that are currently established via each AP 20-1, 20-2 or 20-3.

The method of managing the communication state information for each AP 20-1, 20-2 or 20-3 in the information manager 34 will be briefly described.

First, the information manager 34 assigns identification information to each AP 20-1, 20-2 or 20-3 connected over the network. The information manager 34 also recognizes the amount of traffic that can be handled by each AP 20-1, 20-2 or 20-3, i.e., the number of calls that can be established. For example, a case in which each AP 20-1, 20-2 or 20-3 is capable of simultaneously establishing 32 calls will be considered.

The information manager 34 also manages the identification information of each AP 20-1, 20-2 or 20-3 and information on the number of calls established via each AP 20-1, 20-2 or 20-3.

The information manager 34 may manage the communication state information for the APs 20 in the form of a table such as Table 1.

TABLE 1

| | Identification | MAC address | | Communication |
|---|---|---|---|---|
| | information | information | Call Number | state |
| AP#1 | 0001 | M1 | 20 | N-BUSY |
| AP#2 | 0002 | M2 | 32 | BUSY |
| . . . | . . . | . . . | . . . | . . . |

As shown in Table 1, the information manager 34 manages identification information of the APs 20, MAC address information, information on the number of calls and communication state information. That is, when the number of calls established via an AP 20-1, 20-2 or 20-3 reaches a maximum traffic capacity value of 32, the information manager 34 stores busy state information (BUSY) indicating that the AP 20-1, 20-2 or 20-3 is no longer able to establish new calls.

When the number of calls established via an AP 20-1, 20-2 or 20-3 has not reached the maximum value, the information manager 34 stores idle state information (N-BUSY) indicating that the AP 20-1, 20-2 or 20-3 can establish new calls.

The information manager 34 increments the call number of an AP 20-1, 20-2 or 20-3 by ‘1’ when an additional call is established via the AP 20-1, 20-2 or 20-3 in response to the received call request message from the wireless terminal 10-1, 10-2 or 10-3, and decrements the call number by ‘1’ when the call is terminated.

Meanwhile, the information manager 34 increments the call number by ‘2’ when a call is established between a wireless terminal 10-1, 10-2 or 10-3 connected to the same AP 20-1, 20-2 or 20-3, and decrements the call number by ‘2’ when the call is terminated.

Respective information managed in tabular form by the information manager 34 may be stored in the information storage unit 35.

When the information manager 34 manages communication state information for the APs 20 as in Table 1 and receives a communication state request message including unique information of an AP 20-1, 20-2 or 20-3, e.g., communication state information corresponding to MAC information from a wireless terminal 10-1, 10-2 or 10-3, the information manager 34 transmits a communication state response message including the communication state information for the AP 20-1, 20-2 or 20-3 to the wireless terminal 10-1, 10-2 or 10-3.

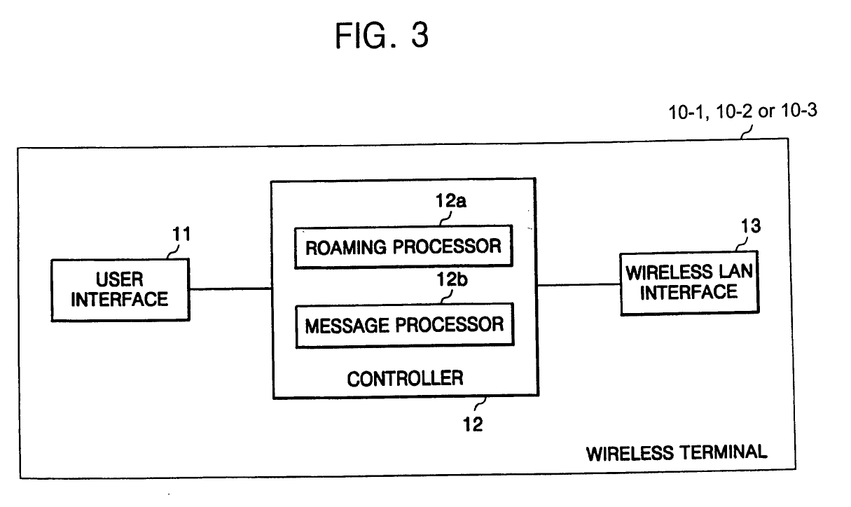

FIG. 3 is a block diagram of the internal structure of a wireless terminal according to a preferred embodiment of the present invention.

Referring to FIG. 3, a wireless terminal 10-1, 10-2 or 10-3 according to the present invention includes a user interface 11, a controller 12, and a wireless LAN interface 13. The controller 12 includes a roaming processor 12a and a message processor 12b.

The wireless LAN interface 13 provides an interface by which messages and packets are wirelessly communicated between the wireless terminal 10-1, 10-2 or 10-3 and a wirelessly connected AP 20-1, 20-2 or 20-3.

The user interface 11 provides an input signal to the controller 12 in response to a user's request, outputs voice information according to packets received from another wireless terminal 10-1, 10-2 or 10-3 when a VoIP call is established, and provides a voice signal according to input voice information from the user to the controller 12.

The controller 12 generates packets based on the voice signal provided by the user interface 11, and provides a voice signal based on packets received via the AP 20-1, 20-2 or 20-3 to the user interface 11.

The controller 12 also generates a call request message in response to the input signal received from the user interface 11, transmits it to the VoIP server 30 via the wirelessly connected AP 20-1, 20-2 or 20-3, and generates a response message to a call request message received from the VoIP server 30.

Upon initial operation, the controller 12 scans for wirelessly-connectable APs 20, and performs an authentication process and an association process to make a wireless connection to an AP 20-1, 20-2 or 20-3 in an idle state and having sufficient signal strength.

The message processor 12b transmits a communication state request message to the VoIP server 30 using the unique information of the AP 20-1, 20-2 or 20-3 scanned by the controller 12 (e.g., MAC address information), recognizes communication state information of the AP 20-1, 20-2 or 20-3 included in a communication state response message received from the VoIP server 30, and allows the controller 12 to establish a call with the AP 20-1, 20-2 or 20-3 if it is in an idle state.

When the wireless terminal 10-1, 10-2 or 10-3 establishes a call via an AP 20-2 or 20-3 and the signal strength of the AP 20-1, 20-2 or 20-3 becomes so weak that it is necessary to roam to a neighboring AP 20-1, 20-2 or 20-3, the roaming processor 12a transmits a roaming confirmation message to the message processor 12b.

When the message processor 12b receives the roaming confirmation message from the roaming processor 12a, it transmits a communication state request message using MAC address information of a scanned AP 20-1, 20-2 or 20-3 to the VoIP server 30, and then provides the communication state information of the AP 20-1, 20-2 or 20-3 included in the received communication state confirmation message.

When the communication state information indicates that the neighboring AP 20-1, 20-2 or 20-3 is idle, the roaming processor 12a performs hand-over so as to move a call to the neighboring AP 20-1, 20-2 or 20-3 20-1, and when the communication state information indicates that the neighboring AP 20-1, 20-2 or 20-3 is busy, the roaming processor 12a does not perform hand-over but maintains the call established via the currently connected AP 20-1, 20-2 or 20-3.

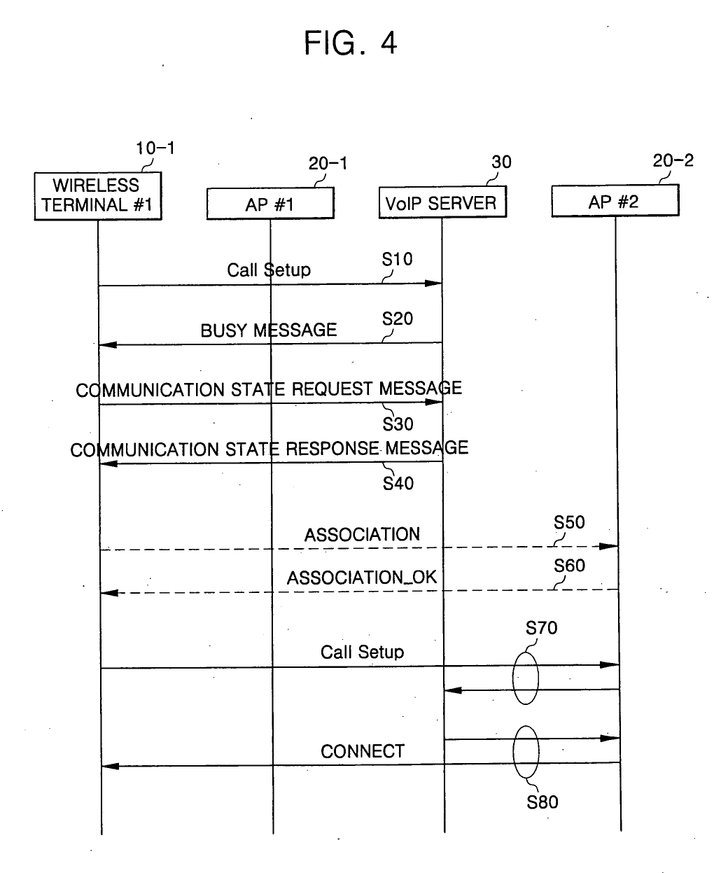

FIG. 4 is a flowchart illustrating establishment of a call in a wireless terminal according to a preferred embodiment of the present invention.

Referring to FIG. 4, the VoIP server 30 manages the communication state information of the APs 20, the first wireless terminal 10-1 scans for an AP 20-1, 20-2 or 20-3 to connect to, performs an authentication process and an association process, and then wirelessly connects to the first AP 20-1.

The VoIP server 30 manages the communication state information according to identification information or MAC address information that is unique to each of the APs 20. The VoIP server 30 also manages unique information about the first wireless terminal 10-1 and unique information about the first AP 20-1 to which the first wireless terminal 10-1 is connected. That is, the VoIP server 30 manages information on the position at which the first wireless terminal 10-1 is connected.

The first wireless terminal 10-1 generates a call request message (call setup) in response to a user's selection, and transmits the call request message to the VoIP server 30 via the first AP 20-1 (S10).

When the VoIP server 30 receives the call request message from the first wireless terminal 10-1, it confirms communication state information of the first AP 20-1 to which the first wireless terminal 10-1 is wirelessly connected. That is, the VoIP server 30 confirms the communication state information of the first AP 20-1 depending on the position information of the first wireless terminal 10-1.

When the communication state information for the first AP 20-1 indicates a busy state in which communication is impossible, the VoIP server 30 transmits a busy message to the first wireless terminal 10-1 (S20).

Upon receipt of the busy message, the first wireless terminal 10-1 transmits a communication state request message to the VoIP server 30 so as to inquire about the communication state of a scanned AP 20-1, 20-2 or 20-3 (S30).

The first wireless terminal 10-1 may include, in the communication state request message, MAC address information that is unique to the scanned AP 20-1, 20-2 or 20-3.

The VoIP server 30 transmits to the first wireless terminal 10-1 a communication state response message including the communication state information for the AP 20-1, 20-2 or 20-3 corresponding to MAC address information included in the communication state request message received from the first wireless terminal 10-1 (S40).

The first wireless terminal 10-1 wirelessly connects to the AP 20-1, 20-2 or 20-3 if it is idle according to the communication state information included in the received communication state response message (S50 and S60).

For example, since the communication state information for the first AP 20-1 indicates the idle state, the first wireless terminal 10-1 wirelessly connects to the second AP 20-2 in an idle state through an authentication process and an association process.

When the first wireless terminal 10-1 is wirelessly connected to the second AP 20-2, it transmits a call request message (call setup) to the VoIP server 30 via the second AP 20-2 (S70).

The VoIP server 30 forwards the call request message from the first wireless terminal 10-1 to the receiving wireless terminal, and upon receipt of a response message, the VoIP server 30 establishes a call between the receiving wireless terminal and the first wireless terminal 10-1 (S80).

Accordingly, when the communication state of the first currently connected AP 20-1 is a busy state, the first wireless terminal 10-1 may establish a call via the second AP 20-2 in an idle state after confirming the communication state information for the initially scanned AP 20-1, 20-2 or 20-3.

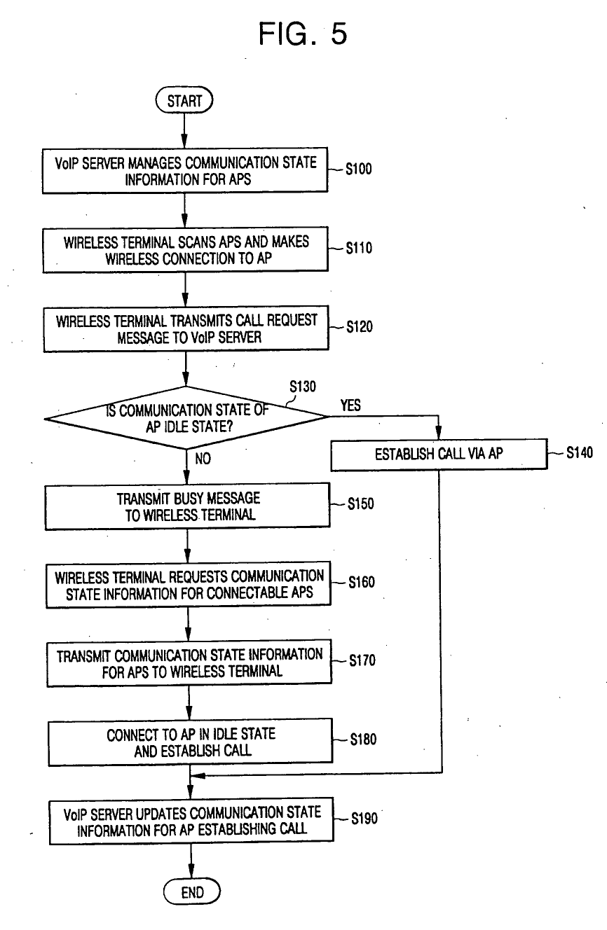

FIG. 5 is a flowchart illustrating a method for providing call service in a wireless local area network system according to a first preferred embodiment of the present invention.

Referring to FIG. 5, a VoIP server 30 manages communication state information for APs 20 connected over the network (S100).

The VoIP server 30 assigns unique identification information to each of the APs 20, and manages identification information for each of the APs 20, MAC address information, information on the number of calls currently established by each of the APs 20, and communication state information.

When the wireless terminal 10-1, 10-2 or 10-3 is initially driven or re-booted, it scans for wirelessly connectable APs 20, and wirelessly connects to an AP 20-1, 20-2 or 20-3 having sufficient signal strength through an authentication process and an association process (S110).

The wireless terminal 10-1, 10-2 or 10-3 transmits to the VoIP server 30 a position confirmation message including MAC address information for the wirelessly connected AP 20-1, 20-2 or 20-3. The VoIP server 30 may manage the MAC address information for the AP 20-1, 20-2 or 20-3 to which the wireless terminal 10-1, 10-2 or 10-3 is connected through the received position confirmation message.

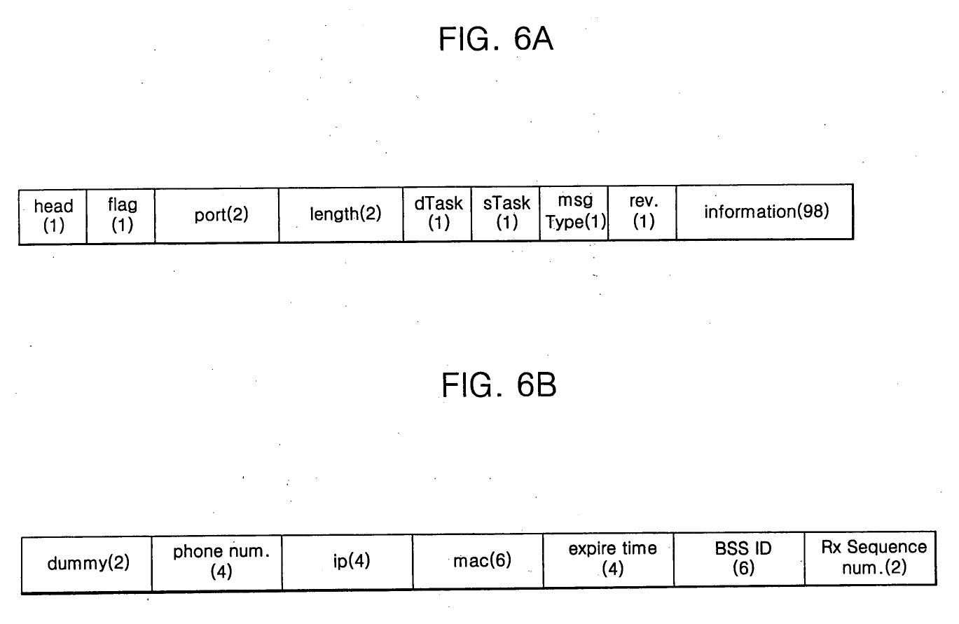

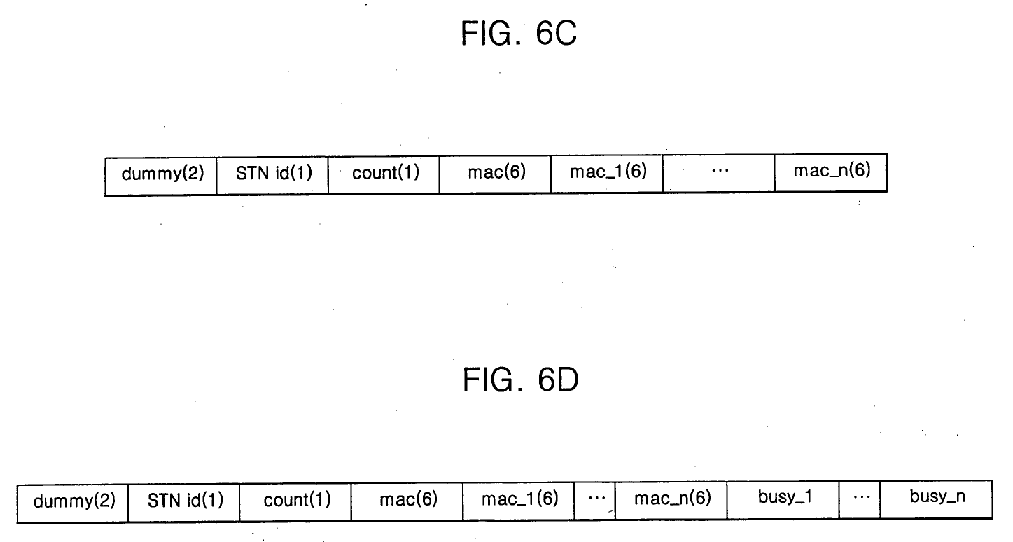

FIG. 6A is a diagram of a message according to a preferred embodiment of the present invention.

As shown in FIG. 6A, a message exchanged between a wireless terminal 10-1, 10-2 or 10-3 and the VoIP server 30 is composed of a one-byte head field, a one-byte flag field, a two-byte port field, a two-byte length field, a one-byte destination task (dTask) field, a one-byte source task (sTask) field, a one-byte message type (msg Type) field, a one-byte reserved field, and a 98-byte information field.

The head field contains header information (0x7e) of the message. The flag field, the port field, and the reserved field include information (0x80, 0x0000) for matching formats for the message to be exchanged over the network.

The length field includes length information of data included in the information field, the destination task field includes information identifying a task about which the message is received, and the source task field includes information identifying a task about which the message is transmitted.

The message type field includes a type of the message, i.e., message type information.

For example, the message type information of a position confirmation message (LOCATION_IND) that the wireless terminal 10-1, 10-2 or 10-3 transmits to the VoIP server 30 may be set as “0xd2”, the message type information of the communication state request message (AP_BUSY_INFO_RQ) may be set as “0xf7”, and the message type information of the communication state response message (AP_BUSY_INFO_RESP) may be set as “0xf6”.

The information field includes position information, identification information, MAC address information, communication state information, and the like for the wireless terminals 10 and APs 20, depending on the message type.

FIG. 6B is a diagram of a position confirmation message according to an embodiment of the present invention.

FIG. 6B shows information fields of the position confirmation message (LOCATION_IND). The information fields include a 4-byte phone number field including information on a telephone number assigned to the wireless terminal 10-1, 10-2 or 10-3, a 4-byte IP address field including IP address information of the wireless terminal 10-1, 10-2 or 10-3, a 6-byte MAC address field including a MAC address of the wirelessly connected AP 20-1, 20-2 or 20-3, an expiry time field including expiry time information of the message, a BSS ID field including information unique to a base service set (BSS) to which the wireless terminal 10-1, 10-2 or 10-3 belongs, and a transmit sequence (Rx sequence) field including sequence information for the message.

That is, the message processor 12b of the wireless terminal 10-1, 10-2 or 10-3 wirelessly connects to a scanned AP 20-1, 20-2 or 20-3 having sufficient signal strength, and then transmits a position confirmation message including MAC address information of the AP 20-1, 20-2 or 20-3 to the VoIP server 30.

The VoIP server 30 manages the position information for the wireless terminal 10-1, 10-2 or 10-3, i.e., information on the AP 20-1, 20-2 or 20-3 to which the wireless terminal 10-1, 10-2 or 10-3 is connected according to the MAC address information of the AP 20-1, 20-2 or 20-3 included in the position confirmation message received from the wireless terminal 10-1, 10-2 or 10-3.

FIG. 6C is a diagram of a communication state request message according to a preferred embodiment of the present invention.

FIG. 6C shows information fields of a communication state request message (AP_BUSY_INFO_RQ). The information fields include a one-byte terminal information field (STN id) including unique information assigned to the wireless terminal 10-1, 10-2 or 10-3, e.g., MAC address information or ID information assigned by the VoIP server 30, a one-byte count field including information on a number of APs 20 for which the communication state information will be confirmed through scanning, a 6-byte MAC address field including the MAC address information for the wireless terminal 10-1, 10-2 or 10-3, and a plurality of MAC address fields including the MAC address information for APs 20 for which the communication state information will be confirmed.

When a busy message is received from the VoIP server 30 or the signal strength of the AP 20-1, 20-2 or 20-3 becomes weak during communication, the wireless terminal 10-1, 10-2 or 10-3 transmits a communication state request message, including MAC address information of the respective AP 20-1, 20-2 or 20-3, to the VoIP server 30 in order to request communication state information for neighboring APs 20.

When the VoIP server 30 receives the communication state request message, it transmits to wireless terminal 10-1, 10-2 or 10-3 a communication state response message including the communication state information for the respective APs 20 as in Table 1.

FIG. 6D is a diagram of a communication state response message according to an embodiment of the present invention.

FIG. 6D shows information fields of a communication state response message. The information fields include a one-byte terminal identification field (STN id) containing identification information of a wireless terminal transmitting a communication state request message, a one-byte count field containing information on a number of APs 20 that will transmit communication state information, a six-byte MAC address field containing MAC address information for the VoIP server 30, a plurality of MAC address fields including MAC address information for APs 20 included in a communication state request message received from the wireless terminal 10-1, 10-2 or 10-3, and a plurality of communication state fields (busy) containing communication state information of a plurality of APs 20.

The VoIP server 30 recognizes communication state information for the APs 20 that use the MAC address information included in the received communication state request message, and then transmits to the wireless terminal 10-1, 10-2 or 10-3 the MAC address information for the APs 20 and the communication state response message sequentially containing the communication state information for the APs 20.

Referring to FIG. 5, the wireless terminal 10-1, 10-2 or 10-3 wirelessly connected to an AP 20-1, 20-2 or 20-3 transmits a call request message to the VoIP server 30 in response to a user's request (S120).

When the VoIP server 30 receives the call request message from the wireless terminal 10-1, 10-2 or 10-3, the wireless terminal 10-1, 10-2 or 10-3 confirms the communication state information of the connected AP 20-1, 20-2 or 20-3. That is, the VoIP server 30 determines whether the communication state information for the AP 20-1, 20-2 or 20-3 corresponding to the MAC address information included in the position confirmation message received from the wireless terminal 10-1, 10-2 or 10-3 indicates an idle state (S130).

When the AP 20-1, 20-2 or 20-3 is in an idle state, the VoIP server 30 transmits a call request message to a receiving wireless terminal, and then establishes a call via the AP 20-1, 20-2 or 20-3 to which the wireless terminal 10-1, 10-2 or 10-3 connects (S140).

The VoIP server 30 increments the call number and updates the idle state information of the AP 20-1, 20-2 or 20-3 (S190) establishing the call.

On the other hand, the VoIP server 30 transmits a busy message to the wireless terminal 10-1, 10-2 or 10-3 when the communication state of the AP 20-1, 20-2 or 20-3 to which the wireless terminal 10-1, 10-2 or 10-3 connects is a busy state (S150).

When the wireless terminal 10-1, 10-2 or 10-3 receives the busy message from the VoIP server 30, it transmits a communication state request message (as in FIG. 6C), including the MAC address information of the scanned APs 20, to the VoIP server 30 (S160).

The VoIP server 30 transmits to the wireless terminal 10-1, 10-2 or 10-3 a communication state response message, including the communication state information for the AP 20-1, 20-2 or 20-3 corresponding to the MAC address information contained in the communication state request message (S170).

The VoIP server 30 transmits to the wireless terminal 10-1, 10-2 or 10-3 the communication state response message (as in FIG. 6D), containing the MAC address information and the communication state information for the respective APs 20.

The wireless terminal 10-1, 10-2 or 10-3 wirelessly connects to a neighboring AP 20-1, 20-2 or 20-3 depending on the signal strength and the communication state of the respective scanned APs 20, and then transmits the call request message to the VoIP server 30.

That is, the wireless terminal 10-1, 10-2 or 10-3 roams to an AP 20-1, 20-2 or 20-3 in an idle state and having sufficient signal strength, and then transmits the call request message to the VoIP server 30.

The VoIP server 30 establishes a call via the new AP 20-1, 20-2 or 20-3 in response to the received call request message from the wireless terminal 10-1, 10-2 or 10-3 (S180).

The VoIP server 30 also increments the call number and updates the communication state information of the AP 20-1, 20-2 or 20-3 establishing the call (S190).

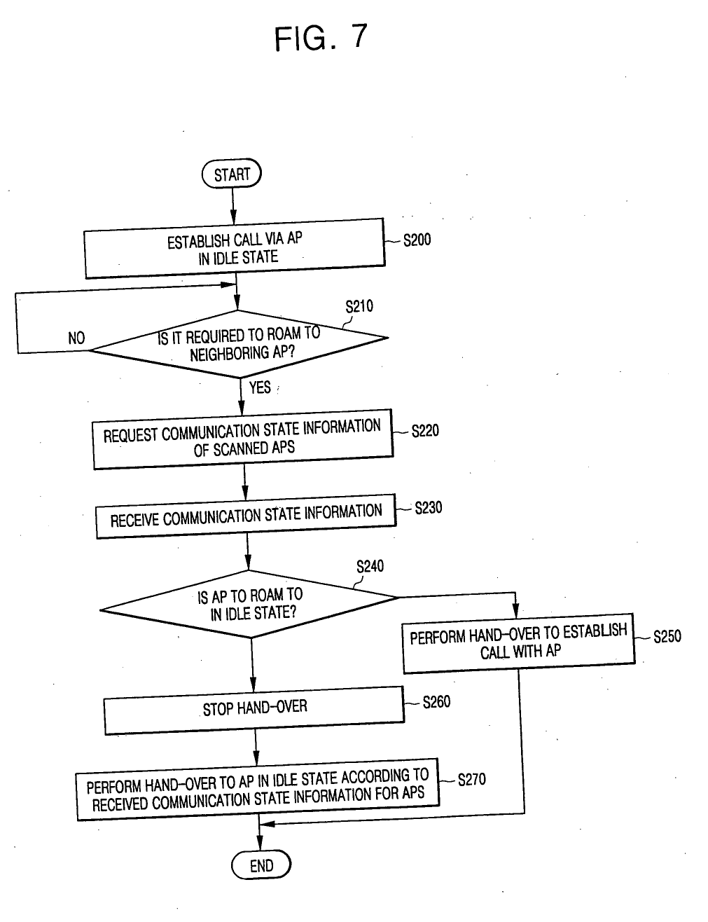

FIG. 7 is a flowchart illustrating a method for providing call service in a wireless local area network system according to a second preferred embodiment of the present invention.

Referring to FIG. 7, the wireless terminal 10-1, 10-2 or 10-3 wirelessly connects to an AP 20-1, 20-2 or 20-3 through a scanning process, an authentication process, and an association process for wireless connection to the AP 20-1, 20-2 or 20-3. When the VoIP server 30 receives the call request message from the wireless terminal 10-1, 10-2 or 10-3, it establishes a call through a currently connected AP 20-1, 20-2 or 20-3 (S200).

That is, the VoIP server 30 establishes the call through the AP 20-1, 20-2 or 20-3 to which the wireless terminal 10-1, 10-2 or 10-3 is connected when that AP 20-1, 20-2 or 20-3 is in an idle state.

The wireless terminal 10-1, 10-2 or 10-3 determines whether to roam to a neighboring AP 20-1, 20-2 or 20-3 due to a weak signal exchanged with the current AP 20-1, 20-2 or 20-3 while the call is established (S210).

When the wireless terminal 10-1, 10-2 or 10-3 determines that hand-over is required to re-establish the call via the neighboring AP 20-1, 20-2 or 20-3, it transmits a communication state request message to the VoIP server 30 to request communication state information of scanned APs 20 (S220).

The VoIP server 30 transmits to the wireless terminal 10-1, 10-2 or 10-3 a communication state response message, including the communication state information for the APs 20 that use the MAC address information included in the communication state request message (S230).

The wireless terminal 10-1, 10-2 or 10-3 confirms whether the communication state information for the AP 20-1, 20-2 or 20-3 to be roamed to, included in the communication state response message, indicates an idle state (S240).

That is, the wireless terminal 10-1, 10-2 or 10-3 transmits the communication state request message, including the MAC address information of the neighboring AP 20-1, 20-2 or 20-3, to the VoIP server 30, and recognizes the communication state information for the AP 20-1, 20-2 or 20-3 from the received communication state response message.

When the communication state information of the neighboring AP 20-1, 20-2 or 20-3 indicates an idle state, the wireless terminal 10-1, 10-2 or 10-3 is wirelessly connected to the neighboring AP 20-1, 20-2 or 20-3, and performs a hand-over process to re-establish the call (S250).

When the communication state information of the neighboring AP 20-1, 20-2 or 20-3 corresponds to a busy state, the wireless terminal 10-1, 10-2 or 10-3 does not perform hand-over to connect to the neighboring AP 20-1, 20-2 or 20-3, but maintains the call established with the connected AP 20-1, 20-2 or 20-3 (S260).

The wireless terminal 10-1, 10-2 or 10-3 recognizes the AP 20-1, 20-2 or 20-3 in the idle state from the received communication state response message while maintaining the call via the presently connected AP 20-1, 20-2 or 20-3.

The wireless terminal 10-1, 10-2 or 10-3 performs the hand-over to establish a call via the neighboring AP 20-1, 20-2 or 20-3 when the neighboring AP 20-1, 20-2 or 20-3 is idle and signal strength is sufficient (S270).

As described above, according to the present invention, when the number of calls that can be established via an AP has reached a maximum value in a wireless local area network system, it is possible to manage communication state information for a plurality of APs and automatically roam to a neighboring AP to establish a call upon receipt of a call request.

Also, in the case where a wireless terminal having an established call is required to hand-over to a neighboring AP, it is also possible to prevent call termination and quality deterioration by not performing hand-over when the neighboring AP is in a busy state.

While the present invention has been described with reference to exemplary embodiments thereof, it will be understood by those skilled in the art that various changes in form and detail may be made therein without departing from the scope of the present invention as defined by the following claims.

What is claimed is:

1. A wireless local area network system including a plurality of wireless terminals and at least one access point (AP), said system comprising:
a server for transmitting a communication state response message, including communication state information depending on information about scanned APs, to the wireless terminal upon receipt from the wireless terminal of a communication state request message including the information about the APs; and
at least one wireless terminal for transmitting the communication state request message, including the information about the APs, to the server, and for making a wireless connection to an AP in an idle state according to the communication state information included in the communication state response message.

2. The system according to claim 1, wherein said at least one wireless terminal generates the communication state request message including address information of at least one scanned AP.

3. The system according to claim 1, wherein said at least one wireless terminal transmits the communication state request message to the server prior to transmitting a call service request message to the server in response to a request of a user.

4. The system according to claim 1, wherein when said at least one wireless terminal determines that hand-over to a second neighboring AP is required in a state where a call is established via a first AP, said at least one wireless terminal transmits the communication state request message, including unique information about respective scanned APs, to the server, and maintains the call established via the first AP when communication state information for the second AP, recognized from the received communication state response message, is a busy state.

5. The system according to claim 1, wherein the server assigns identification information to respective APs, and manages at least one of the identification information assigned to the respective APs, address information, information on a number of calls that can be established, information on a number of currently established calls, and communication state information which depends on the information on the number of calls that can be established and the information on the number of currently established calls.

6. The system according to claim 1, wherein the server transmits the communication state response message to said at least one wireless terminal, the communication state response message including communication state information that corresponds to information unique to each of the APs included in the communication state request message received from said at least one wireless terminal.

7. The system according to claim 1, wherein the communication state request message includes at least one of information unique to each wireless terminal, information on a number of the scanned APs, and MAC address information of the APs.

8. The system according to claim 7, wherein the information unique to said each wireless terminal is any one of MAC address information, identification information assigned by the server, telephone number information, and base service set (BSS) identifier (ID) information.

9. The system according to claim 1, wherein the communication state response message includes at least one of information unique to said at least one wireless terminal transmitting the communication state request message, information on a number of the APs, MAC address information for the server, MAC address information for the APs, and communication state information for the APs.

10. A server for providing a call service in a wireless local area network system including at least one wireless terminal and access points (APs), said server comprising:
an information manager for recognizing communication state information from information on a number of calls established via each AP and for transmitting a communication state response message to said at least one wireless terminal, the communication state response message including communication state information for APs in response to a received communication state request message from said at least one wireless terminal; and
a call processor for transmitting a call service request message from said at least one wireless terminal to a receiving wireless terminal, and then establishing a call via the AP to which said at least one wireless terminal is connected.

11. The server according to claim 10, wherein the information manager recognizes information on a number of calls that can be established and information on a number of currently established calls for each AP, and when the numbers are the same for a given AP, recognizes the communication state information for said given AP to be busy state information.

12. A wireless terminal for a wireless local area network system including a plurality of access points (APs) and a call service providing server, said wireless terminal comprising:
a message processor for transmitting a communication state request message to the server to request communication state information for scanned APs, and providing the communication state information included in a received communication state response message; and
a controller for making a wireless connection to an AP in an idle state according to the communication state information provided by the message processor, and then transmitting a call service request message to the server.

13. The wireless terminal according to claim 12, further comprising:
a roaming processor for processing roaming according to communication state information for a second AP provided by the message processor when it is determined that hand-over to the second AP is required based on the strength of a signal exchanged with a first AP to which the controller has made a wireless connection.

14. A method for providing a call service in a wireless local area network system including at least one wireless terminal, access points (APs), and a call service providing server, said method comprising the steps of:
recognizing, by the server, communication state information for APs connected over a network;
transmitting, by each wireless terminal, a communication state request message to the server to request communication state information for scanned APs;
transmitting, by the server, a communication state response message including the communication state information for the APs to said each wireless terminal;
making, by said each wireless terminal, a wireless connection to an AP in an idle state based on the communication state information in the communication state response message, and then transmitting a call service request message to the server; and
establishing, by the server, a call with said each wireless terminal via the AP in the idle state.

15. The method according to claim 14, further comprising the steps of:
transmitting, by said each wireless terminal, the service request message to the server;
transmitting, by the server, a busy message to said each wireless terminal when the communication state information of an AP to which said each wireless terminal is connected is busy state information;
transmitting, by said each wireless terminal, the communication state request message to the server upon receipt of the busy message; and
roaming, by said each wireless terminal, to a neighboring AP, and then transmitting the service request message to the server when the communication state information for the neighboring AP included in the received communication state response message is idle state information.

16. The method according to claim 14, wherein the step of recognizing communication state information for the APs comprises the steps of:
assigning, by the server, identification information to the APs connected over the network and recognizing address information;
recognizing information on a number of calls that can be established and information on a number of currently established calls for each AP;
storing communication state information depending on the information on the number of calls that can be established and the information on the number of currently established calls, so as to correspond to at least one of the identification information and the address information of the respective APs; and
changing the information on the number of the currently established calls to update the communication state information when one of establishment and termination of the call takes place via said each AP.

17. The method according to claim 14, further comprising the steps of:
transmitting, by said each wireless terminal, the communication state request message to the server when it is determined that hand-over to the second AP is required based on the strength of a signal exchanged in a state where a call is established via the first AP; and
maintaining, by said each wireless terminal, the call established with the first AP when the communication state information for the second AP, included in the communication state response message received from the server, indicates a busy state.

18. A method for providing a call service in a wireless local area network system comprising at least one wireless terminal, access points (APs), and a call service providing server, the method comprising the steps of:
recognizing communication state information based on information on a number of calls that can be established and information on a number of currently established calls for each AP;
transmitting a communication state response message, including communication state information for respective APs and information unique to said each AP, to said at least one wireless terminal upon receipt of a communication state request message from said at least one wireless terminal; and
establishing a call for providing the call service in response to a received service request message from said at least one wireless terminal.

19. A method for providing a call service for a wireless terminal in a wireless local area network system comprising a plurality of access points (APs) and a call service providing server, the method comprising the steps of:
transmitting a communication state request message to the server to request communication state information for scanned APs, and then recognizing communication state information for the APs from a received communication state response message;
selecting a second AP that is in an idle state and has excellent signal strength when communication state information of a first AP of the scanned APs having the highest signal strength indicates a busy state; and
making a wireless connection to the second AP through an authentication process and an association process so as to transmit a call service request message to the server.

20. The method according to claim 19, further comprising the steps of:
transmitting the communication state request message to the server when it is determined that hand-over to the second AP is required based on the strength of a signal exchanged while a call is established via the first AP;
maintaining the call established with the first AP when the communication state information for the second AP indicates a busy state; and
performing hand-over to the second AP through an authentication process and an association process when the communication state information for the second AP indicates an idle state.
